(19) United States
(12) Patent Application Publication
(10) Pub. No.: US 2023/0407080 A1
(43) Pub. Date: Dec. 21, 2023

(54) Thermoplastic Resin Composition and Molded Article Formed Therefrom

(71) Applicant: LOTTE CHEMICAL CORPORATION, Seoul (KR)

(72) Inventor: Sung Oh EIM, Uiwang-si (KR)

(21) Appl. No.: 18/037,167

(22) PCT Filed: Nov. 9, 2021
(86) PCT No.: PCT/KR2021/016187

§ 371 Date: May 16, 2023

(30) Foreign Application Priority Data
Dec. 11, 2020 (KR) 10-2020-0173657

(51) Int. Cl. C08L 55/02; C08L 9/06; C08K 5/20; C08L 23/08; C08L 25/12; C08L 23/12

(52) U.S. Cl. CPC C08L 55/02; C08L 9/06; C08K 5/20; C08L 23/0815; C08L 25/12; C08L 23/12; C08L 2205/025; C08L 2205/035; C08L 2201/08; C08L 2203/30; C08L 2207/53

(57) ABSTRACT

A thermoplastic resin composition of the present invention comprises: about 100 parts by weight of a rubber-modified aromatic vinyl-based copolymer resin; about 2 to 23 parts by weight of a rubber-modified polystyrene resin; about 2 to 23 parts by weight of a polyolefin resin; about 1 to 13 parts by weight of a saturated fatty acid bis amide; about 1 to 13 parts by weight of a styrene-butadiene rubbery polymer; and about 1 to 13 parts by weight of an ethylene-α-olefin rubbery polymer. The thermoplastic resin composition has excellent chemical resistance, processability, impact resistance, hardness, heat resistance, etc.

### TECHNICAL FIELD

The present invention relates to a thermoplastic resin composition and a molded article formed therefrom. More particularly, the present invention relates to a thermoplastic resin composition that exhibits good properties in terms of chemical resistance, processability, impact resistance, rigidity, heat resistance, and the like, and a molded article formed therefrom.

### BACKGROUND ART

A rubber-modified aromatic vinyl copolymer resin, such as an acrylonitrile-butadiene-styrene copolymer resin (ABS resin) and the like, has good properties in terms of mechanical properties, processability, appearance characteristics, and the like, and is extensively used as interior/exterior materials for electric/electronic products, interior/exterior materials for automobiles, exterior materials for buildings, and the like.

In recent years, with increasing tendency toward improvement in chemical resistance of materials, there is a need for a thermoplastic resin composition having much better chemical resistance and processability (injection moldability) than conventional rubber-modified aromatic vinyl copolymer resins.

Although the rubber-modified aromatic vinyl copolymer resin can achieve improvement in processability through reduction in content of a vinyl cyanide monomer, the ratio of a rubber-modified vinyl graft copolymer, and the molecular weight of the resin, there can be a problem of deterioration in chemical resistance and the like. In addition, when a typical olefin-based additive having chemical resistance is added to improve chemical resistance, there can be a problem of deterioration in fluidity, mechanical properties, and the like.

Therefore, there is a need for development of a thermoplastic resin composition having good properties in terms of chemical resistance, processability, impact resistance, rigidity, heat resistance, and the like without causing such problems.

The background technique of the present invention is disclosed in Korean Patent Registration No. 10-0760457 and the like.

### DISCLOSURE

### Technical Problem

It is one aspect of the present invention to provide a thermoplastic resin composition having good properties in terms of chemical resistance, processability, impact resistance, rigidity, heat resistance, and the like.

It is another aspect of the present invention to provide a molded article formed from the thermoplastic resin composition.

The above and other aspects of the present invention can be achieved by the present invention described below.

### Technical Solution

1. One aspect of the present invention relates to a thermoplastic resin composition. The thermoplastic resin composition comprises: about 100 parts by weight of a rubber-modified aromatic vinyl copolymer resin; about 2 to about 23 parts by weight of a rubber-modified polystyrene resin; about 2 to about 23 parts by weight of a polyolefin resin; about 1 to about 13 parts by weight of a saturated fatty acid bis-amide; about 1 to about 13 parts by weight of a styrene-butadiene rubber polymer; and about 1 to about 13 parts by weight of an ethylene-α-olefin rubber polymer.

2. In embodiment 1, the rubber-modified aromatic vinyl copolymer resin may comprise a rubber-modified vinyl graft copolymer and an aromatic vinyl copolymer resin.

3. In embodiment 1 or 2, the rubber-modified vinyl graft copolymer may be prepared through graft polymerization of a monomer mixture comprising an aromatic vinyl monomer and a vinyl cyanide monomer to a rubber polymer.

4. In embodiments 1 to 3, the rubber-modified polystyrene resin may be a polymer comprising about 3 to about 30 wt % of the rubber polymer and about 70 to about 97 wt % of the aromatic vinyl monomer.

5. In embodiments 1 to 4, the polyolefin resin may comprise at least one of polypropylene, polyethylene, and a propylene-ethylene copolymer.

6. In embodiments 1 to 5, the saturated fatty acid bis-amide may comprise at least one of methylene bis-stearamide, methylene bis-oleamide, ethylene bis-stearamide, ethylene bis-oleamide, hexamethylene bis-stearamide, and hexamethylene bis-oleamide.

7. In embodiments 1 to 6, the styrene-butadiene rubber polymer may be a polymer of a monomer mixture comprising about 25 to about 45 wt % of styrene and about 55 to about 75 wt % of butadiene.

8. In embodiments 1 to 7, the ethylene-α-olefin rubber polymer may be a polymer of a monomer mixture comprising about 25 to about 55 wt % of ethylene and about 45 to about 75 wt % of α-olefin.

9. In embodiments 1 to 8, a weight ratio of the rubber-modified polystyrene resin to the polyolefin resin may range from about 1:0.2 to about 1:5.

10. In embodiments 1 to 9, a weight ratio of the saturated fatty acid bis-amide to the styrene-butadiene rubber polymer may range from about 1:0.2 to about 1:4.

11. In embodiments 1 to 10, a weight ratio of the styrene-butadiene rubber polymer to the ethylene-α-olefin rubber polymer may range from about 1:0.2 to about 1:4.

12. In embodiments 1 to 11, the thermoplastic resin composition may have a crack generation strain (ε) of about 1.0 to about 1.4%, as calculated using a specimen having a size of 200 mm×50 mm×2 mm according to Equation 1, in which the specimen is mounted on a ¼ elliptical jig (major axis length: 120 mm, minor axis length: 34 mm), coated with 10 ml of olive oil or isopropanol, and left for 24 hours:

$$ε = \frac{{b}^{2}}{2 \times {a}^{2}} \times {\{ 1 - \frac{( {a}^{2} - {b}^{2} )}{{a}^{4}} \times {x}^{2} \}}^{- 3 / 2} \times t \times 100 \qquad [ Equation 1 ]$$

where ε denotes the crack generation strain, a denotes the major axis length (mm) of the elliptical jig, b denotes the minor axis length (mm) of the elliptical jig, t denotes the thickness (mm) of the specimen, and x denotes a distance from a perpendicular intersection between a crack generation location and the major axis of the elliptical jig to a central point of the elliptical jig.

13. In embodiments 1 to 12, the thermoplastic resin composition may have a spiral flow length of about 210 to about 280 mm, as measured on a specimen after injection molding of the specimen in a spiral-shaped mold having a size of 15 mm width and 1 mm thickness under conditions of a molding temperature of 230° C., a mold temperature of 60° C., an injection pressure of 100 MPa, and an injection rate of 100 mm/s.

14. In embodiments 1 to 13, the thermoplastic resin composition may have a notched Izod impact strength of about 12 to about 30 kgf·cm/cm, as measured on a ¼″ thick specimen in accordance with ASTM D256, a tensile strength of about 290 to about 380 kgf/cm², as measured on a 3.2 mm thick specimen under conditions of mm/min in accordance with ASTM D638, and a Vicat softening temperature of about 79 to about 90° C., as measured under a load of 5 kg at 50° C./hr in accordance with ISO R306.

15. Another aspect of the present invention relates to a molded article. The molded article is formed from the thermoplastic resin composition according to any one of embodiments 1 to 14.

### Advantageous Effects

The present invention provides a thermoplastic resin composition having good properties in terms of chemical resistance, processability, impact resistance, rigidity, heat resistance, and the like, and a molded article formed therefrom.

### BEST MODE

Hereinafter, exemplary embodiments of the present invention will be described in detail.

A thermoplastic resin composition according to the present invention comprises: (A) a rubber-modified aromatic vinyl copolymer resin; (B) a rubber-modified polystyrene resin; (C) a polyolefin resin; (D) a saturated fatty acid bis-amide; (E) a styrene-butadiene rubber polymer; and (F) an ethylene-α-olefin rubber polymer.

As used herein to represent a specific numerical range, the expression “a to b” is defined as “≥a and ≤b”.

(A) Rubber-Modified Aromatic Vinyl Copolymer Resin

The rubber-modified aromatic vinyl copolymer resin according to one embodiment of the invention may comprise (A1) a rubber-modified vinyl graft copolymer and (A2) an aromatic vinyl copolymer resin.

(A1) Rubber-Modified Vinyl Graft Copolymer

The rubber-modified vinyl graft copolymer according to one embodiment of the invention may be prepared through graft polymerization of a monomer mixture comprising an aromatic vinyl monomer and a vinyl cyanide monomer to a rubber polymer. For example, the rubber-modified vinyl graft copolymer may be prepared through graft polymerization of the monomer mixture comprising the aromatic vinyl monomer and the vinyl cyanide monomer to the rubber polymer and, optionally, the monomer mixture may further comprise a monomer for imparting processability and heat resistance. Here, polymerization may be performed by any suitable polymerization method known in the art, such as emulsion polymerization, suspension polymerization, and the like. Further, the rubber-modified vinyl graft copolymer may have a core (rubber polymer)-shell (copolymer of the monomer mixture) structure, without being limited thereto.

In some embodiments, the rubber polymer may comprise diene rubbers, such as polybutadiene, poly(acrylonitrile-butadiene), and the like, saturated rubbers prepared by adding hydrogen to the diene rubbers, isoprene rubbers, C₂ to C₁₀ alkyl (meth)acrylate rubbers, copolymers of C₂ to C₁₀ alkyl (meth)acrylate rubbers and styrene, ethylene-propylene-diene terpolymer (EPDM), and the like. These may be used alone or as a mixture thereof. For example, the rubber polymer may comprise diene rubbers, (meth)acrylate rubbers, and the like, specifically butadiene rubbers, butyl acrylate rubbers, and the like.

In some embodiments, the rubber polymer (rubber particles) may have an average particle diameter of about 0.05 to about 6 μm, for example, about 0.15 to about 4 μm, specifically about 0.25 to about 3.5 μm. Within this range, the thermoplastic resin composition can have good impact resistance, appearance characteristics, and the like. Here, the average (Z-average) particle diameter of the rubber polymer (rubber particles) may be measured by a light scattering method in a latex state. Specifically, a rubber polymer latex is filtered through a mesh to remove coagulum generated during polymerization of the rubber polymer. Then, a mixed solution of 0.5 g of the latex and 30 ml of distilled water is placed in a 1,000 ml flask, which in turn is filled with distilled water to prepare a specimen. Then, 10 ml of the specimen is transferred to a quartz cell, followed by measurement of the average particle diameter of the rubber polymer using a light scattering particle analyzer (Malvern Co., Ltd., Nano-zs).

In some embodiments, the rubber polymer may be present in an amount of about 20 to about 80 wt %, for example, about 25 to about 70 wt %, based on 100 wt % of the rubber-modified vinyl graft copolymer and the monomer mixture (comprising the aromatic vinyl monomer and the vinyl cyanide monomer) may be present in an amount of about 20 to about 80 wt %, for example, about 30 to about 75 wt %, based on 100 wt % of the rubber-modified vinyl graft copolymer. Within this range, the thermoplastic resin composition can have good properties in terms of impact resistance, appearance characteristics, and the like.

In some embodiments, the aromatic vinyl monomer may be graft copolymerizable with the rubber polymer and may comprise, for example, styrene, α-methyl styrene, β-methyl styrene, p-methyl styrene, p-t-butyl styrene, ethyl styrene, vinylxylene, monochlorostyrene, dichlorostyrene, dibromostyrene, vinyl naphthalene, and the like. These may be used alone or as a mixture thereof. The aromatic vinyl monomer may be present in an amount of about 10 to about 90 wt %, for example, about 20 to about 80 wt %, based on 100 wt % of the monomer mixture. Within this range, the thermoplastic resin composition can have good properties in terms of processability, impact resistance, and the like.

In some embodiments, the vinyl cyanide monomer is a monomer copolymerizable with the aromatic vinyl monomer and may comprise, for example, acrylonitrile, methacrylonitrile, ethacrylonitrile, phenyl acrylonitrile, α-chloroacrylonitrile, fumaronitrile, and the like, without being limited thereto. These may be used alone or as a mixture thereof. For example, the vinyl cyanide monomer may be acrylonitrile, methacrylonitrile, and the like. The vinyl cyanide monomer may be present in an amount of about 10 to about 90 wt %, for example, about 20 to about 80 wt %, based on 100 wt % of the monomer mixture. Within this range, the thermoplastic resin composition can have good properties in terms of chemical resistance, mechanical properties, and the like.

In some embodiments, the monomer for imparting processability and heat resistance may comprise, for example, (meth)acrylic acid, C₁ to C₁₀ alkyl (meth)acrylates, maleic anhydride, N-substituted maleimide, and the like, without being limited thereto. The monomer for imparting processability and heat resistance may be present in an amount of about 60 wt % or less, for example, about 1 to about 50 wt %, based on 100 wt % of the monomer mixture. Within this range, the monomer for imparting processability and heat resistance can impart processability and heat resistance to the thermoplastic resin composition without deterioration in other properties.

In some embodiments, the rubber-modified vinyl graft copolymer may comprise a graft copolymer (g-ABS) prepared by grafting a styrene monomer as the aromatic vinyl compound and an acrylonitrile monomer as the vinyl cyanide compound to a butadiene rubber polymer, and the like.

In some embodiments, the rubber-modified vinyl graft copolymer may be present in an amount of about 10 to about 50 wt %, for example, about 15 to about 45 wt %, based on 100 wt % of the rubber-modified aromatic vinyl copolymer resin. Within this range, the thermoplastic resin composition can have good impact resistance, fluidity (molding processability), and the like.

(A2) Aromatic Vinyl Copolymer Resin

The aromatic vinyl copolymer resin according to one embodiment of the invention may comprise an aromatic vinyl copolymer resin used in typical rubber-modified aromatic vinyl copolymer resins. For example, the aromatic vinyl copolymer resin may be a polymer of a monomer mixture comprising an aromatic vinyl monomer and a vinyl cyanide monomer.

In some embodiments, the aromatic vinyl copolymer resin may be prepared by mixing the aromatic vinyl monomer with the vinyl cyanide monomer, followed by polymerization of the mixture. Here, polymerization may be performed by any suitable polymerization method known in the art, such as emulsion polymerization, suspension polymerization, bulk polymerization, and the like.

In some embodiments, the aromatic vinyl monomer may comprise styrene, α-methyl styrene, β-methyl styrene, p-methyl styrene, p-t-butyl styrene, ethyl styrene, vinylxylene, monochlorostyrene, dichlorostyrene, dibromostyrene, vinyl naphthalene, and the like, without being limited thereto. These may be used alone or as a mixture thereof. The aromatic vinyl monomer may be present in an amount of 60 to 90 wt %, for example, 65 to 85 wt %, based on 100 wt % of the aromatic vinyl copolymer resin. Within this range, the thermoplastic resin composition can have good properties in terms of impact resistance, fluidity, appearance characteristics, and the like.

In some embodiments, the vinyl cyanide monomer may comprise acrylonitrile, methacrylonitrile, ethacrylonitrile, phenyl acrylonitrile, α-chloroacrylonitrile, fumaronitrile, and the like, without being limited thereto. These may be used alone or as a mixture thereof. For example, the vinyl cyanide monomer may comprise acrylonitrile, methacrylonitrile, and the like. The vinyl cyanide monomer may be present in an amount of about 10 to about 40 wt %, for example, about 15 to about 35 wt %, based on 100 wt % of the aromatic vinyl copolymer resin. Within this range, the thermoplastic resin composition can have good properties in terms of impact resistance, fluidity, heat resistance, appearance characteristics, and the like.

In some embodiments, the aromatic vinyl copolymer resin may further comprise a monomer for imparting processability and heat resistance to the monomer mixture. The monomer for imparting processability and heat resistance may comprise, for example, (meth)acrylic acid, N-substituted maleimide, and the like, without being limited thereto. The monomer for imparting processability and heat resistance may be present in an amount of about 15 wt % or less, for example, about 0.1 to about 10 wt %, based on 100 wt % of the monomer mixture. Within this range, the monomer for imparting processability and heat resistance can impart processability and heat resistance to the thermoplastic resin composition without deterioration in other properties.

In some embodiments, the aromatic vinyl copolymer resin may have a weight average molecular weight (Mw) of about 10,000 to about 300,000 g/mol, for example, about 20,000 to about 200,000 g/mol, as measured by gel permeation chromatography (GPC). Within this range, the thermoplastic resin composition can have good mechanical strength, molding processability, and the like.

In some embodiments, the aromatic vinyl copolymer resin may be present in an amount of about 50 to about 90 wt %, for example, about 55 to about 85 wt %, based on 100 wt % of the rubber-modified aromatic vinyl copolymer resin. Within this range, the thermoplastic resin composition can exhibit good properties in terms of impact resistance, fluidity (molding processability), and the like.

(B) Rubber-Modified Polystyrene Resin

The rubber-modified polystyrene resin according to one embodiment of the invention serves to improve impact resistance, rigidity, and the like of the thermoplastic resin composition, and may be a polymer, for example, a typical high impact resistant polystyrene (HIPS) resin, prepared through polymerization of a rubber polymer and an aromatic vinyl monomer.

In some embodiments, the rubber polymer may comprise diene rubbers, such as polybutadiene, poly(acrylonitrile-butadiene), and the like, saturated rubbers prepared by adding hydrogen to the diene rubbers, isoprene rubbers, C₂ to C₁₀ alkyl (meth)acrylate rubbers, copolymers of C₂ to C₁₀ alkyl (meth)acrylate rubbers and styrene, ethylene-propylene-diene terpolymer (EPDM), and the like. These may be used alone or as a mixture thereof. For example, the rubber polymer may comprise diene rubbers, (meth)acrylate rubbers, and the like, specifically butadiene rubbers, butyl acrylate rubbers, and the like.

In some embodiments, the rubber polymer (rubber particles) may have an average particle diameter of about 0.05 to about 6 μm, for example, about 0.15 to about 4 μm, specifically about 0.25 to about 3.5 μm. Within this range, the thermoplastic resin composition can have good impact resistance, appearance characteristics, and the like. Here, the average (Z-average) particle diameter of the rubber polymer (rubber particles) may be measured by a light scattering method in a latex state. Specifically, a rubber polymer latex is filtered through a mesh to remove coagulum generated during polymerization of the rubber polymer. Then, a mixed solution of 0.5 g of the latex and 30 ml of distilled water is placed in a 1,000 ml flask, which in turn is filled with distilled water to prepare a specimen. Then, 10 ml of the specimen is transferred to a quartz cell, followed by measurement of the average particle diameter of the rubber polymer using a light scattering particle analyzer (Malvern Co., Ltd., Nano-zs).

In some embodiments, the rubber polymer may be present in an amount of about 3 to about 30 wt %, for example, about 5 to about 20 wt %, based on 100 wt % of the rubber-modified polystyrene resin. Within this range, the thermoplastic resin composition can have good properties in terms of impact resistance, appearance characteristics, and the like.

In some embodiments, the aromatic vinyl monomer may comprise, for example, styrene, α-methylstyrene, β-methylstyrene, p-methylstyrene, p-t-butylstyrene, ethylstyrene, vinylxylene, monochlorostyrene, dichlorostyrene, dibromostyrene, vinyl naphthalene, and the like. These may be used alone or as a mixture thereof. The aromatic vinyl monomer may be present in an amount of about 70 to about 97 wt %, for example, about 80 to about 95 wt %, based on 100 wt % of the rubber-modified polystyrene resin. Within this range, the thermoplastic resin composition can have good properties in terms of processability, impact resistance, and the like.

In some embodiments, a monomer, such as acrylonitrile, acrylic acid, methacrylic acid maleic anhydride, N-substituted maleimide, and the like may be further added to the rubber-modified polystyrene resin to impart properties, such as chemical resistance, processability, and heat resistance to the thermoplastic resin composition. In this case, the monomer may be added in an amount of about 40 wt % or less based on 100 wt % of the rubber-modified polystyrene resin. Within this range, the monomer can impart chemical resistance, processability, and heat resistance to the thermoplastic resin composition without deterioration in other properties.

In some embodiments, the rubber-modified polystyrene resin may be prepared through heat polymerization without an initiator or may be prepared through polymerization in the presence of the initiator. The initiator may comprise at least one of a peroxide-based initiator, such as benzoyl peroxide, t-butyl hydroperoxide, acetyl peroxide, cumene hydroperoxide, and the like, and an azo-based initiator, such as azobis-isobutyronitrile and the like. The rubber-modified polystyrene resin may be prepared by a polymerization method well known in the art, such as bulk polymerization, suspension polymerization, emulsion polymerization, and the like.

In some embodiments, the rubber-modified polystyrene resin may be present in an amount of about 2 to about 23 parts by weight, for example, about 3 to about 20 parts by weight, relative to about 100 parts by weight of the rubber-modified aromatic vinyl copolymer resin. If the content of the rubber-modified polystyrene resin is less than about 2 parts by weight, the thermoplastic resin composition can suffer from deterioration in impact resistance and the like, and if the content of the rubber-modified polystyrene resin exceeds about 23 parts by weight, the thermoplastic resin composition can suffer from deterioration in processability, heat resistance, rigidity, and the like.

(C) Polyolefin Resin

The polyolefin resin according to one embodiment of the invention serves to improve chemical resistance, processability, and the like of the thermoplastic resin composition and may be a typical polyolefin resin. For example, the polyolefin resin may comprise polyethylene resins, such as low density polyethylene (LDPE), middle density polyethylene (MOPE), high density polyethylene (HDPE), linear low density polyethylene (LLDPE), and the like; polypropylene resins, such as polypropylene, propylene-ethylene copolymers, propylene-1-butene copolymers, mixtures thereof, and the like; polymers thereof; blends comprising polyisobutene; combinations thereof, and the like. Specifically, the polyolefin resin may be polypropylene, polyethylene, a propylene-ethylene copolymer, or a combination thereof.

In some embodiment, the polyolefin resin may have a melt-flow index of about 0.5 to about 50 g/10 min, for example, about 1 to about 30 g/10 min, as measured at 230° C. under a load of 2.16 kg in accordance with ASTM D1238. Within this range, the thermoplastic resin composition can have good chemical resistance, processability, and the like.

In some embodiments, the polyolefin resin may be present in an amount of about 2 to about 23 parts by weight, for example, about 3 to about 20 parts by weight, relative to about 100 parts by weight of the rubber-modified aromatic vinyl copolymer resin. If the content of the polyolefin resin is less than about 2 parts by weight, the thermoplastic resin composition can suffer from deterioration in chemical resistance and the like, and the content of the polyolefin resin exceeds about 23 parts by weight, the thermoplastic resin composition can suffer from deterioration in impact resistance, heat resistance, rigidity, and the like.

In some embodiments, the rubber-modified polystyrene resin (B) and the polyolefin resin (C) may be present in a weight ratio (B:C) of about 1:0.2 to about 1:5, for example, about 1:0.25 to about 1:4. Within this range, the thermoplastic resin composition can exhibit better properties in terms of chemical resistance, impact resistance, heat resistance, rigidity, balance therebetween, and the like.

(D) Saturated Fatty Acid Bis-Amide

The saturated fatty acid bis-amide according to one embodiment of the invention serves to improve chemical resistance, processability, impact resistance, rigidity, heat resistance, balance therebetween and the like of the thermoplastic resin composition together with the rubber-modified aromatic vinyl copolymer resin, the rubber-modified polystyrene resin, the polyolefin resin, the styrene-butadiene rubber polymer, the ethylene-α-olefin rubber polymer, and the like, and may be a typical saturated fatty acid bis-amide.

In some embodiments, the saturated fatty acid bis-amide may comprise methylene bis-stearamide, methylene bis-oleamide, ethylene bis-stearamide, ethylene bis-oleamide, hexamethylene bis-stearamide, hexamethylene bis-oleamide, combinations thereof, and the like.

In some embodiments, the saturated fatty acid bis-amide may be present in an amount of about 1 to about 13 parts by weight, for example, about 1 to about 10 parts by weight, relative to about 100 parts by weight of the rubber-modified aromatic vinyl copolymer resin. If the content of the saturated fatty acid bis-amide is less than about 1 part by weight, the thermoplastic resin composition can suffer from deterioration in processability and the like, and if the content of the saturated fatty acid bis-amide exceeds about 13 parts by weight, the thermoplastic resin composition can suffer from deterioration in heat resistance and the like.

(E) Styrene-Butadiene Rubber Polymer

The styrene-butadiene rubber polymer according to one embodiment of the invention serves to improve chemical resistance, processability, impact resistance, rigidity, heat resistance, balance therebetween, and the like of the thermoplastic resin composition together with the rubber-modified aromatic vinyl copolymer resin, the rubber-modified polystyrene resin, the polyolefin resin, the saturated fatty acid bis-amide, the ethylene-α-olefin rubber polymer, and the like.

In some embodiments, the styrene-butadiene rubber polymer may be a polymer of a monomer mixture comprising about 25 to about 45 wt %, for example, about 25 to about 35 wt %, of styrene and about 55 to about 75 wt %, for example, about 65 to about 75 wt %, of butadiene. Within this range, the thermoplastic resin composition can have good impact resistance, rigidity, and the like.

In some embodiments, the styrene-butadiene rubber polymer may have a melt-flow index of about 1 to about 10 g/10 min, for example, about 3 to about 8 g/10 min, as measured at 200° C. under a load of 5 kg in accordance with ASTM D1238. Within this range, the thermoplastic resin composition can have good impact resistance, rigidity, and the like.

In some embodiments, the styrene-butadiene rubber polymer may be present in an amount of about 1 to about 13 parts by weight, for example, about 1 to about 10 parts by weight, relative to about 100 parts by weight of the rubber-modified aromatic vinyl copolymer resin. If the content of the styrene-butadiene rubber polymer is less than about 1 part by weight, the thermoplastic resin composition can suffer from deterioration in impact resistance and the like, and if the content of the styrene-butadiene rubber polymer exceeds about 13 parts by weight, the thermoplastic resin composition can suffer from deterioration in processability, heat resistance, rigidity, and the like.

In some embodiments, the saturated fatty acid bis-amide (D) and the styrene-butadiene rubber polymer (E) may be present in a weight ratio (D:E) of about 1:0.2 to about 1:4, for example, about 1:0.3 to about 1:3.4. Within this range, the thermoplastic resin composition can exhibit good properties in terms of chemical resistance, impact resistance, heat resistance, rigidity, balance therebetween, and the like.

(F) Ethylene-α-olefin Rubber Polymer

The ethylene-α-olefin rubber polymer according to one embodiment serves to improve chemical resistance, processability, impact resistance, rigidity, heat resistance, balance therebetween, and the like of the thermoplastic resin composition

together with the rubber-modified aromatic vinyl copolymer resin, the rubber-modified polystyrene resin, the polyolefin resin, the saturated fatty acid bis-amide, the styrene-butadiene rubber polymer, and the like.

In some embodiments, the ethylene-α-olefin rubber polymer may be a polymer of a monomer mixture comprising about 25 to about 55 wt %, for example, about 30 to about 50 wt %, of ethylene and about 45 to about 75 wt %, for example, about 50 to about 70 wt %, of α-olefin. Within this range, the thermoplastic resin composition can have good impact resistance, toughness, and the like.

In some embodiments, the ethylene-α-olefin rubber polymer may comprise at least one of ethylene-1-octene copolymer, ethylene-1-butene copolymer, ethylene-1-pentene copolymer, ethylene-1-hexene copolymer, ethylene-1-heptene copolymer, ethylene-1-decene copolymer, ethylene-1-undecene copolymer, and ethylene-1-dodecene copolymer.

In some embodiments, the ethylene-α-olefin rubber polymer may have a specific gravity of about 0.85 to about 0.88, for example, about 0.86 to about 0.87, as measured in accordance with ASTM D792, and a melt-flow index of about 0.5 to about 5, for example, about 0.5 to about 2, as measured at 190° C. under a load of 2.16 kg in accordance with ASTM D1238. Within this range, the thermoplastic resin composition can have good impact resistance, toughness, and the like.

In some embodiments, the ethylene-α-olefin rubber polymer may be present in an amount of about 1 to about 13 parts by weight, for example, about 1 to about 10 parts by weight, relative to about 100 parts by weight of the rubber-modified aromatic vinyl copolymer resin. If the content of the ethylene-α-olefin rubber polymer is less than about 1 part by weight, the thermoplastic resin composition can suffer from deterioration in impact resistance and the like, and if the content of the ethylene-α-olefin rubber polymer exceeds about 13 parts by weight, the thermoplastic resin composition can suffer from deterioration in heat resistance, rigidity, and the like.

In some embodiments, the styrene-butadiene rubber polymer (E) and the ethylene-α-olefin rubber polymer (F) may be present in a weight ratio (E:F) of about 1:0.2 to about 1:4, for example, about 1:0.3 to about 1:3.4. Within this range, the thermoplastic resin composition can have better properties in terms of chemical resistance, impact resistance, heat resistance, rigidity, balance therebetween, and the like.

The thermoplastic resin composition according to one embodiment of the invention may further comprise additives used for typical thermoplastic resin compositions. The additives may comprise organic/inorganic fillers, antioxidants, flame retardants, anti-dripping agents, nucleating agents, antistatic agents, stabilizers, pigments, dyes, mixtures thereof, and the like, without being limited thereto. The additives may be present in an amount of about 0.001 to about 40 parts by weight, for example, about 0.1 to about 10 parts by weight, relative to about 100 parts by weight of the rubber-modified aromatic vinyl copolymer resin.

The thermoplastic resin composition according to one embodiment of the invention may be prepared in pellet form by mixing the aforementioned components, followed by melt extrusion at about 180 to about 280° C., for example, about 200 to about 260° C., using a typical twin-screw extruder.

The thermoplastic resin composition may have a crack generation strain (ε) of about 1.0 to about 1.4%, for example, about 1.1 to about 1.38%, as calculated using a specimen having a size of 200 mm×50 mm×2 mm according to Equation 1, in which the specimen is mounted on a ¼ elliptical jig (major axis length: 120 mm, minor axis length: 34 mm), coated with 10 ml of olive oil or isopropanol, and left for 24 hours:

$$ε = \frac{{b}^{2}}{2 \times {a}^{2}} \times {\{ 1 - \frac{( {a}^{2} - {b}^{2} )}{{a}^{4}} \times {x}^{2} \}}^{- 3 / 2} \times t \times 100 \qquad [ Equation 1 ]$$

where ε denotes the crack generation strain, a denotes the major axis length (mm) of the elliptical jig, b denotes the minor axis length (mm) of the elliptical jig, t denotes the thickness (mm) of the specimen, and x denotes a distance from a perpendicular intersection between a crack generation location and the major axis of the elliptical jig to a central point of the elliptical jig.

In some embodiments, the thermoplastic resin composition may have a spiral flow length of about 210 to about 280 mm, for example, about 220 to about 280 mm, as measured on a specimen after injection molding of the specimen in a spiral-shaped mold having a size of 15 mm width and 1 mm thickness under conditions of a molding temperature of 230° C., a mold temperature of 60° C., an injection pressure of 100 MPa, and an injection rate of 100 mm/s.

In some embodiments, the thermoplastic resin composition may have a notched Izod impact strength of about 12 to about 30 kgf·cm/cm, for example, about 13 to about 25 kgf·cm/cm, as measured on a ¼″ thick specimen in accordance with ASTM D256.

In some embodiments, the thermoplastic resin composition may have a tensile strength of about 290 to about 380 kgf/cm², for example, about 300 to about 380 kgf/cm², as measured on a 3.2 mm thick specimen under conditions of 50 mm/min in accordance with ASTM D638.

In some embodiments, the thermoplastic resin composition may have a Vicat softening temperature of about 79° C. to about 92° C., for example, about 80° C. to about 90° C., as measured under a load of 5 kg at 50° C./hr in accordance with ISO R306.

A molded article according to the present invention is formed from the thermoplastic resin composition set forth above. The thermoplastic resin composition may be prepared in pellet form. The prepared pellets may be produced into various molded articles (products) by various molding methods, such as injection molding, extrusion molding, vacuum molding, casting, and the like. These molding methods are well known to those skilled in the art. The molded product has good properties in terms of chemical resistance, processability, impact resistance, rigidity, heat resistance, balance therebetween, and the like, and thus can be advantageously used for interior/exterior materials for electric/electronic products, housings for daily products, and the like.

### MODE FOR INVENTION

Next, the present invention will be described in more detail with reference to some examples. It should be understood that these examples are provided for illustration only and are not to be construed in any way as limiting the invention.

### EXAMPLE

Details of components used in Examples and Comparative Examples are as follows.

(A) Rubber-modified aromatic vinyl copolymer resin

A mixture of 25 wt % of (A1) a rubber-modified aromatic vinyl copolymer and 75 wt % of (A2) an aromatic vinyl copolymer resin was used.

(A1) Rubber-modified aromatic vinyl copolymer

A core-shell type graft copolymer (g-ABS) prepared by graft copolymerization of 42 wt % of styrene and acrylonitrile (weight ratio: 75/25) to 58 wt % of butadiene rubbers having an average particle size of 0.3 μm was used.

(A2) Aromatic vinyl copolymer resin

A SAN resin (weight average molecular weight: 140,000 g/mol) prepared by polymerization of 80 wt % of styrene and 20 wt % of acrylonitrile was used.

(B) Rubber-modified polystyrene resin

A high impact resistant polystyrene (HIPS) resin (Manufacturer: Styrolution, Product Name: PS576H) was used.

(C) Polyolefin resin

A polypropylene resin having a melt flow index (MI) of 12 g/10 min as measured at 230° C. under a load of 2.16 kg in accordance with ASTM D1238 (Manufacturer: Lotte Chemical Co., Ltd., Product Name: B-311) was used.

(D) Saturated fatty acid bis-amide

An ethylene bis-stearamide (Manufacturer: Shinwon Chemical Co., Ltd., Product Name: HI-LUB B-50) was used.

(E1) A styrene-butadiene rubber polymer (SBR, Manufacturer: Kumho Petrochemical Co., Ltd., Product Name: KTR-201, styrene content: 31.5 wt %) was used.

(E2) A styrene-ethylene-butadiene-styrene copolymer (SEBS, Manufacturer: KRATON, Product Name: G1652) was used.

(F1) An ethylene-1-octene rubber polymer (EOR, Manufacturer: DOW, Product Name: ENGAGE8150) was used as an ethylene-α-olefin rubber polymer.

(F2) An ethylene methyl acrylate copolymer (EMA, Manufacturer: Dupont Product Name: Elvaloy AC1330) was used.

### Examples 1 to 11 and Comparative Examples 1 to 12

The above components were mixed in amounts as listed in Tables 1, 2, 3 and 4 and subjected to extrusion at 230° C., thereby preparing pellets. Here, extrusion was performed using a twin-screw extruder (L/D=36, diameter: 45 mm) and the pellets were dried at 80° C. for 4 hours or more and injection-molded in a 6 oz. injection molding machine (molding temperature: 230° C., mold temperature: 60° C.), thereby preparing specimens. The specimens were evaluated as to the following properties by the following method, and results are shown in Tables 1, 2, 3 and 4.

Property Evaluation

(1) Chemical resistance: Crack generation strain (ε, unit: %) was calculated using a specimen having a size of 200 mm×50 mm×2 mm according to Equation 1, in which the specimen was mounted on a ¼ elliptical jig (major axis length: 120 mm, minor axis length: 34 mm), coated with 10 ml of olive oil or isopropanol, and left for 24 hours.

$$ε = \frac{{b}^{2}}{2 \times {a}^{2}} \times {\{ 1 - \frac{( {a}^{2} - {b}^{2} )}{{a}^{4}} \times {x}^{2} \}}^{- 3 / 2} \times t \times 100 \qquad [ Equation 1 ]$$

where ε denotes the crack generation strain, a denotes the major axis length (mm) of the elliptical jig, b denotes the minor axis length (mm) of the elliptical jig, t denotes the thickness (mm) of the specimen, and x denotes a distance from a perpendicular intersection between a crack generation location and the major axis of the elliptical jig to a central point of the elliptical jig.

(2) Processability: Spiral flow length (unit: mm) was measured on a specimen, which was prepared through injection molding in a spiral-shaped mold having a size of 15 mm width and 1 mm thickness under conditions of a molding temperature of 230° C., a mold temperature of 60° C., an injection pressure of 100 MPa, and an injection rate of 100 mm/s.

(3) Impact resistance: Notched Izod impact strength (kgf·cm/cm) was measured on a ¼″ thick specimen in accordance with ASTM D256.

(4) Tensile strength (TS, unit: kgf/cm²): Tensile strength was measured on a 3.2 mm thick specimen at 50 mm/min in accordance with ASTM D638.

(5) Vicat Softening Temperature (VST) (unit: ° C.): Vicat softening temperature was measured under a load of 5 kg at 50° C./hr in accordance with ISO 306.

TABLE 1

| | Example | | | | |
|---|---|---|---|---|---|
| | 1 | 2 | 3 | 4 | 5 |
| (A) (parts by weight) | 100 | 100 | 100 | 100 | 100 |
| (B) (parts by weight) | 3 | 5 | 20 | 5 | 5 |
| (C) (parts by weight) | 5 | 5 | 5 | 3 | 20 |
| (D) (parts by weight) | 3 | 3 | 3 | 3 | 3 |
| (E1) (parts by weight) | 3 | 3 | 3 | 3 | 3 |
| (E2) (parts by weight) | — | — | — | — | — |
| (F1) (parts by weight) | 3 | 3 | 3 | 3 | 3 |
| (F2) (parts by weight) | — | — | — | — | — |
| Crack generation | 1.22 | 1.26 | 1.28 | 1.10 | 1.38 |
| strain (ε) | | | | | |
| Spiral flow length | 270 | 260 | 220 | 260 | 280 |
| Notched Izod impact | 15 | 20 | 25 | 20 | 13 |
| strength | | | | | |
| Tensile strength | 380 | 370 | 300 | 380 | 300 |
| Heat resistance (VST) | 87 | 87 | 80 | 87 | 82 |

TABLE 2

| | Example | | | | | |
|---|---|---|---|---|---|---|
| | 6 | 7 | 8 | 9 | 10 | 11 |
| (A) (parts by weight) | 100 | 100 | 100 | 100 | 100 | 100 |
| (B) (parts by weight) | 5 | 5 | 5 | 5 | 5 | 5 |
| (C) (parts by weight) | 5 | 5 | 5 | 5 | 5 | 5 |
| (D) (parts by weight) | 1 | 10 | 3 | 3 | 3 | 3 |
| (E1) (parts by weight) | 3 | 3 | 1 | 10 | 3 | 3 |
| (E2) (parts by weight) | — | — | — | — | — | — |
| (F1) (parts by weight) | 3 | 3 | 3 | 3 | 1 | 10 |
| (F2) (parts by weight) | — | — | — | — | — | — |
| Crack generation | 1.26 | 1.26 | 1.20 | 1.28 | 1.24 | 1.26 |
| strain (ε) | | | | | | |
| Spiral flow length | 220 | 280 | 280 | 220 | 280 | 220 |
| Notched Izod impact | 20 | 20 | 13 | 25 | 13 | 25 |
| strength | | | | | | |
| Tensile strength | 370 | 370 | 360 | 300 | 370 | 300 |
| Heat resistance (VST) | 90 | 82 | 90 | 81 | 87 | 80 |

TABLE 3

| | Comparative Example | | | | | |
|---|---|---|---|---|---|---|
| | 1 | 2 | 3 | 4 | 5 | 6 |
| (A) (parts by weight) | 100 | 100 | 100 | 100 | 100 | 100 |
| (B) (parts by weight) | 1 | 25 | 5 | 5 | 5 | 5 |
| (C) (parts by weight) | 5 | 5 | 1 | 25 | 5 | 5 |
| (D) (parts by weight) | 3 | 3 | 3 | 3 | 0.5 | 15 |
| (El) (parts by weight) | 3 | 3 | 3 | 3 | 3 | 3 |
| (E2) (parts by weight) | — | — | — | — | — | — |
| (F1) (parts by weight) | 3 | 3 | 3 | 3 | 3 | 3 |
| (F2) (parts by weight) | — | — | — | — | — | — |
| Crack generation | 1.18 | 1.22 | 0.80 | 1.44 | 1.24 | 1.26 |
| strain (ε) | | | | | | |
| Spiral flow length | 280 | 200 | 280 | 300 | 200 | 320 |
| Notched Izod impact | 11 | 22 | 21 | 10 | 20 | 20 |
| strength | | | | | | |
| Tensile strength | 390 | 280 | 390 | 280 | 370 | 370 |
| Heat resistance (VST) | 88 | 75 | 88 | 78 | 88 | 75 |

TABLE 4

| | Comparative Example | | | | | |
|---|---|---|---|---|---|---|
| | 7 | 8 | 9 | 10 | 11 | 12 |
| (A) (parts by weight) | 100 | 100 | 100 | 100 | 100 | 100 |
| (B) (parts by weight) | 5 | 5 | 5 | 5 | 5 | 5 |
| (C) (parts by weight) | 5 | 5 | 5 | 5 | 5 | 5 |
| (D) (parts by weight) | 3 | 3 | 3 | 3 | 3 | 3 |
| (E1) (parts by weight) | 0.5 | 15 | — | 3 | 3 | 3 |
| (E2) (parts by weight) | — | — | 3 | — | — | — |
| (F1) (parts by weight) | 3 | 3 | 3 | 0.5 | 15 | — |
| (F2) (parts by weight) | — | — | — | — | — | 3 |
| Crack generation | 1.14 | 1.24 | 1.14 | 1.14 | 1.22 | 1.16 |
| strain (ε) | | | | | | |
| Spiral flow length | 290 | 200 | 260 | 290 | 210 | 260 |
| Notched Izod impact | 8 | 22 | 11 | 8 | 27 | 11 |
| strength | | | | | | |
| Tensile strength | 320 | 280 | 350 | 370 | 280 | 350 |
| Heat resistance (VST) | 88 | 75 | 87 | 87 | 74 | 87 |

It could be seen that the thermoplastic resin compositions according to the present invention had good properties in terms of chemical resistance, processability, impact resistance, and the like.

Conversely, it could be seen that the resin composition containing an insufficient amount of the rubber-modified polystyrene resin (Comparative Example 1) suffered from deterioration in impact resistance and the like; and the resin composition containing an excess of the rubber-modified polystyrene resin (Comparative Example 2) suffered from deterioration in processability, heat resistance, rigidity, and the like. It could be seen that the resin composition containing an insufficient amount of the polyolefin resin (Comparative Example 3) suffered from deterioration in chemical resistance and the like; and the resin composition containing an excess of the polyolefin resin (Comparative Example 4) suffered from deterioration in impact resistance, heat resistance, rigidity, and the like. It could be seen that the resin composition containing an insufficient amount of the saturated fatty acid bis-amide (Comparative Example 5) suffered from deterioration in processability and the like; and the resin composition containing an excess of the saturated fatty acid bis-amide (Comparative Example 6) suffered from deterioration in heat resistance and the like. It could be seen that the resin composition containing an insufficient amount of the styrene-butadiene rubber polymer (Comparative Example 7) suffered from deterioration in impact resistance and the like; the resin composition containing an excess of the styrene-butadiene rubber polymer (Comparative Example 8) suffered from deterioration in processability, heat resistance, rigidity, and the like; and the resin composition containing SEBS (E2) (Comparative Example 9) instead of the styrene-butadiene rubber polymer suffered from deterioration in impact resistance and the like. Further, it could be seen that the resin composition containing an insufficient amount of the ethylene-α-olefin rubber polymer (Comparative Example 10) suffered from deterioration in impact resistance and the like; the resin composition containing an excess of the ethylene-α-olefin rubber polymer (Comparative Example 11) suffered from deterioration in heat resistance, rigidity, and the like; and the resin composition containing EMA (F2) (Comparative Example 12) instead of the ethylene-α-olefin rubber polymer suffered from deterioration in impact resistance and the like.

Although the present invention has been described with reference to some example embodiments, it should be understood by those skilled in the art that these embodiments are given by way of illustration only, and that various modifications, variations and alterations can be made without departing from the spirit and scope of the invention. Therefore, the embodiments should not be construed as limiting the technical spirit of the present invention, but should be construed as illustrating the technical spirit of the present invention. The scope of the invention should be interpreted according to the following appended claims as covering all modifications or variations derived from the appended claims and equivalents thereto.

1. A thermoplastic resin composition comprising:
about 100 parts by weight of a rubber-modified aromatic vinyl copolymer resin;
about 2 to about 23 parts by weight of a rubber-modified polystyrene resin;
about 2 to about 23 parts by weight of a polyolefin resin;
about 1 to about 13 parts by weight of a saturated fatty acid bis-amide;
about 1 to about 13 parts by weight of a styrene-butadiene rubber polymer; and
about 1 to about 13 parts by weight of an ethylene-α-olefin rubber polymer.

2. The thermoplastic resin composition according to claim 1, wherein the rubber-modified aromatic vinyl copolymer resin comprises a rubber-modified vinyl graft copolymer and an aromatic vinyl copolymer resin.

3. The thermoplastic resin composition according to claim 2, wherein the rubber-modified vinyl graft copolymer is prepared through graft polymerization of a monomer mixture comprising an aromatic vinyl monomer and a vinyl cyanide monomer to a rubber polymer.

4. The thermoplastic resin composition according to claim 1, wherein the rubber-modified polystyrene resin is a polymer comprising about 3 to about 30 wt % of the rubber polymer and about 70 to about 97 wt % of the aromatic vinyl monomer.

5. The thermoplastic resin composition according to claim 1, wherein the polyolefin resin comprises at least one of polypropylene, polyethylene, and a propylene-ethylene copolymer.

6. The thermoplastic resin composition according to claim 1, wherein the saturated fatty acid bis-amide comprises at least one of methylene bis-stearamide, methylene bis-oleamide, ethylene bis-stearamide, ethylene bis-oleamide, hexamethylene bis-stearamide, and hexamethylene bis-oleamide.

7. The thermoplastic resin composition according to claim 1, wherein the styrene-butadiene rubber polymer is a polymer of a monomer mixture comprising about 25 to about 45 wt % of styrene and about 55 to about 75 wt % of butadiene.

8. The thermoplastic resin composition according to claim 1, wherein the ethylene-α-olefin rubber polymer is a polymer of a monomer mixture comprising about 25 to about 55 wt % of ethylene and about 45 to about 75 wt % of α-olefin.

9. The thermoplastic resin composition according to claim 1, wherein a weight ratio of the rubber-modified polystyrene resin to the polyolefin resin ranges from about 1:0.2 to about 1:5.

10. The thermoplastic resin composition according to claim 1, wherein a weight ratio of the saturated fatty acid bis-amide to the styrene-butadiene rubber polymer ranges from about 1:0.2 to about 1:4.

11. The thermoplastic resin composition according to claim 1, wherein a weight ratio of the styrene-butadiene rubber polymer to the ethylene-α-olefin rubber polymer ranges from about 1:0.2 to about 1:4.

12. The thermoplastic resin composition according to claim 1, wherein the thermoplastic resin composition has a crack generation strain (ε) of about 1.0 to about 1.4%, as calculated using a specimen having a size of 200 mm×50 mm×2 mm according to Equation 1, in which the specimen is mounted on a ¼ elliptical jig (major axis length: 120 mm, minor axis length: 34 mm), coated with 10 ml of olive oil or isopropanol, and left for 24 hours:
$$ε = \frac{{b}^{2}}{2 \times {a}^{2}} \times {\{ 1 - \frac{( {a}^{2} - {b}^{2} )}{{a}^{4}} \times {x}^{2} \}}^{- 3 / 2} \times t \times 100 \qquad [ Equation 1 ]$$
where ε denotes the crack generation strain, a denotes the major axis length (mm) of the elliptical jig, b denotes the minor axis length (mm) of the elliptical jig, t denotes the thickness (mm) of the specimen, and x denotes a distance from a perpendicular intersection between a crack generation location and the major axis of the elliptical jig to a central point of the elliptical jig.

13. The thermoplastic resin composition according to claim 1, wherein the thermoplastic resin composition has a spiral flow length of about 210 to about 280 mm, as measured on a specimen after injection molding of the specimen in a spiral-shaped mold having a size of 15 mm width and 1 mm thickness under conditions of a molding temperature of 230° C., a mold temperature of 60° C., an injection pressure of 100 MPa, and an injection rate of 100 mm/s.

14. The thermoplastic resin composition according to claim 1, wherein the thermoplastic resin composition has a notched Izod impact strength of about 12 to about 30 kgf·cm/cm, as measured on a ¼″ thick specimen in accordance with ASTM D256, a tensile strength of about 290 to about 380 kgf/cm², as measured on a 3.2 mm thick specimen under conditions of 50 mm/min in accordance with ASTM D638, and a Vicat softening temperature of about 79 to about 90° C., as measured under a load of 5 kg at 50° C./hr in accordance with ISO R306.

15. A molded article formed from the thermoplastic resin composition according to claim 1.
